(19) United States
(12) Patent Application Publication
(10) Pub. No.: US 2016/0128377 A1
(43) Pub. Date: May 12, 2016

(54) PRESS

(71) Applicant: ARROW INDUSTRIES, INC., Edgewater, NJ (US)

(72) Inventor: CHAE SONG LEE, Edgewater, NJ (US)

(21) Appl. No.: 14/927,695

(22) Filed: Oct. 30, 2015

Related U.S. Application Data
(60) Provisional application No. 62/076,491, filed on Nov. 7, 2014.

(51) Int. Cl. A23N 1/00

(52) U.S. Cl. CPC A23N 1/00

(57) ABSTRACT

A press includes a top plate, a receive plate, and a pivot mechanism connecting the top plate and the receive plate such that the top plate and the base plate are rotatable relative to each other. The top plate includes a press portion, a first middle portion extending upward and outward from the press portion, a first rim surrounding the first middle portion, and a first pivot portion and a first handle portion extending from the first rim in two opposite directions. The base plate includes a receive portion having multiple through holes at the bottom, a second middle portion extending upward and outward from the receive portion, a second rim surrounding the second middle portion, and a second pivot portion and a second handle portion extending from the second rim in two opposite directions.

### CROSS-REFERENCE TO RELATED PATENT APPLICATIONS

This application claims priority to and the benefit of, pursuant to 35 U.S.C. §119(e), U.S. Provisional Patent Application Ser. No. 62/076,491, filed Nov. 7, 2014, which is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE INVENTION

The invention relates generally to a press, and particularly to a manual fruit press that has an elevated outer ring.

### BACKGROUND OF THE INVENTION

Small fruit press is widely used to obtain fresh made fruit juice. However, manual fruit press is often hard to operate, difficult to clean, easy to leak, and juice remains in the flesh is often much which reduces juice obtained. Thus, it is still a challenge in manufacturing a family friendly fruit press that has a simple structure, is easy to use, generates much juice from the fruit, and easy to clean.

Therefore, a heretofore unaddressed need exists in the art to address the aforementioned deficiencies and inadequacies.

### SUMMARY OF THE INVENTION

In one aspect, the present invention is directed to a press. In one embodiment, the press includes a top plate, a receive plate, and a pivot mechanism connecting the top plate and the receive plate. The top plate includes a press portion having a curved surface or a flat surface, a first middle portion surrounding the press portion and extending upward and outward from the press portion, a first rim surrounding the first middle portion, a first pivot portion, extending from the first rim, and disposed at a first end of the top plate, and a first handle portion extending from the first rim and disposed at a second end of the top plate that is opposite to the first end of the top plate. The base plate is pivoted to the top plate, and include a receive portion having a curved surface or a flat surface and a plurality of through holes disposed at a bottom of the receive portion, a second middle portion surrounding the receive portion and extending upward and outward from the receive portion, a second rim surrounding the second middle portion, a second pivot portion, extending from the second rim, and disposed at a first end of the base plate, and a second handle portion extending from the second rim and disposed at a second end of the base plate that is opposite to the first end of the base plate. The pivot mechanism is configured to connect the top plate with the base plate through the first pivot portion and the second pivotal portion, such that the top plate and the base plate are rotatable relative to each other through the pivot mechanism.

In one embodiment, the press portion includes a first section, a second section surrounding the first section, and a third section surrounding the second section. The first section, the second section and the third section may be curved sections. A curvature of the third section is greater than a curvature of the first section or a curvature of the second section.

In one embodiment, the receive portion includes a fourth section, a fifth section surrounding the fourth section, and a sixth section surrounding the fifth section. The fourth section, the fifth section and the sixth section may be curved sections. A curvature of the sixth section is greater than a curvature of the fourth section or a curvature of the fifth section.

In one embodiment, a largest length of the receive portion along the horizontal direction, when viewing from the top, is about 1.5 inch.

In one embodiment, a largest length of the press portion along the horizontal direction is 0-10% less than the largest length of the receive portion along the horizontal direction.

In one embodiment, the second middle portion has a bottom length along the horizontal direction in a range of 0.5-3 inch, and a top length along the horizontal direction in a range of 3-5 inch. When the top and bottom of the second middle portion is in a circular shape, the bottom length and the top length are the bottom diameter and the top diameter respectively.

In one embodiment, the second middle portion has the top length of 1.5 inch, and the top length of 4 inch.

In one embodiment, a bottom length of the first middle portion is 0-10% less than the bottom length of the second middle portion, and a top length of the first middle portion is substantially the same as the top length of the second middle portion.

In one embodiment, the second middle portion includes a plurality of ridges radially disposed at a top surface of the second middle portion, and a number of the ridges is 6.

In one embodiment, an edge of the top plate faces downward, and an edge of the second handle portion faces upward, such that juice leaking is prevented.

In one embodiment, each of the upper plate and the base plate are integrally formed, and the press is made of stainless steel that is dishwashable.

In another aspect, the present invention relates to a press, specifically a fruit press. In one embodiment, the press includes a top plate, a base plate, and a pivot mechanism. The top plate includes a press portion having a first circular bottom portion and a first ring shaped side portion extending outward and upward from the circular bottom portion, a first middle portion surrounding the press portion extending upward and outward from the press portion and having at least one stepped structure, a first rim surrounding the first middle portion, a first pivot portion extending from the first rim and disposed at a first end of the top plate, and a first handle portion extending from the first rim and disposed at a second end of the top plate that is opposite to the first end of the top plate. The base plate is pivoted to the top plate, and includes a receive portion having a second circular bottom portion, a second ring shaped side portion extending outward and upward from the circular bottom portion, and a plurality of through holes disposed at the second circular bottom portion, a second middle portion surrounding the receive portion extending upward and outward from the receive portion and having at least one stepped structure, a second rim surrounding the second middle portion, a second pivot portion extending from the second rim and disposed at a first end of the base plate, and a second handle portion extending from the second rim and disposed at a second end of the base plate that is opposite to the first end of the base plate. The pivot mechanism is configured to connect the top plate with the base plate through the first pivot portion and the second pivotal portion, such that the top plate and the base plate are rotatable relative to each other through the pivot mechanism.

In one embodiment, a diameter at a top of the second ring shaped side portion is in a range of 1-2 inch, and a diameter of the second circular bottom portion is in a range of 1-1.5 inch.

In one embodiment, a diameter of at a top of the second ring shaped side portion is about 1.5 inch, and a diameter of the second circular bottom portion is about 1.25 inch.

In one embodiment, a size and shape of the press portion are 0-10% smaller than a size and shape of the receive portion.

In one embodiment, each of the first middle portion and the second middle portion includes 3 stepped structures.

In one embodiment, the press is made of stainless steel.

In a further aspect, the present invention relates to a press, especially a fruit press. In one embodiment, the press includes a top plate and a base plate pivoted to the top plate. The top plate includes a press portion having a bowl shape, a first middle portion surrounding the press portion and extending upward and outward from the press portion, and a first rim surrounding the first middle portion. The base plate includes a receive portion having a bowl shape and a plurality of through holes disposed at a bottom thereof, a second middle portion surrounding the receive portion and extending upward and outward from the press portion, and a second rim surrounding the second middle portion.

In one embodiment, a largest dimension of the press portion and the receive portion along the horizontal direction is about 1.5 inch, and a largest dimension of the first rim and the second rim along the horizontal direction is about 4 inch.

In one embodiment, each of the first middle portion and the second middle portion includes 2-6 stepped structures.

In one embodiment, the second middle portion includes a plurality of ridges radially disposed at an inner surface of the second middle portion.

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the disclosure and, together with the written description, serve to explain the principles of the disclosure. The same reference numbers may be used throughout the drawings to refer to the same or like elements in the embodiments.

FIG. 1 shows a schematic three dimensional view of a fruit press according to one embodiment of the present invention.

FIG. 2A shows a schematic sectional side view of a top plate and a base plate of the fruit press of FIG. 1.

FIG. 2B shows a schematic top view of the base plate of FIG. 2A.

FIG. 3A shows a schematic sectional side view of a top plate of a fruit press according to one embodiment of the present invention.

FIG. 3B shows a schematic top view of the top plate of FIG. 3A.

FIG. 3C shows a schematic sectional side view of a base plate of a fruit press according to one embodiment of the present invention.

FIG. 3D shows a schematic top view of the base plate of FIG. 3C.

FIG. 4 shows a schematic three dimensional view of a fruit press according to one embodiment of the present invention.

FIG. 5A shows a schematic sectional side view of a top plate and a base plate of the fruit press of FIG. 4.

FIG. 5B shows a schematic top view of the base plate of FIG. 5A.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about” “substantially” or “approximately” can be inferred if not expressly stated.

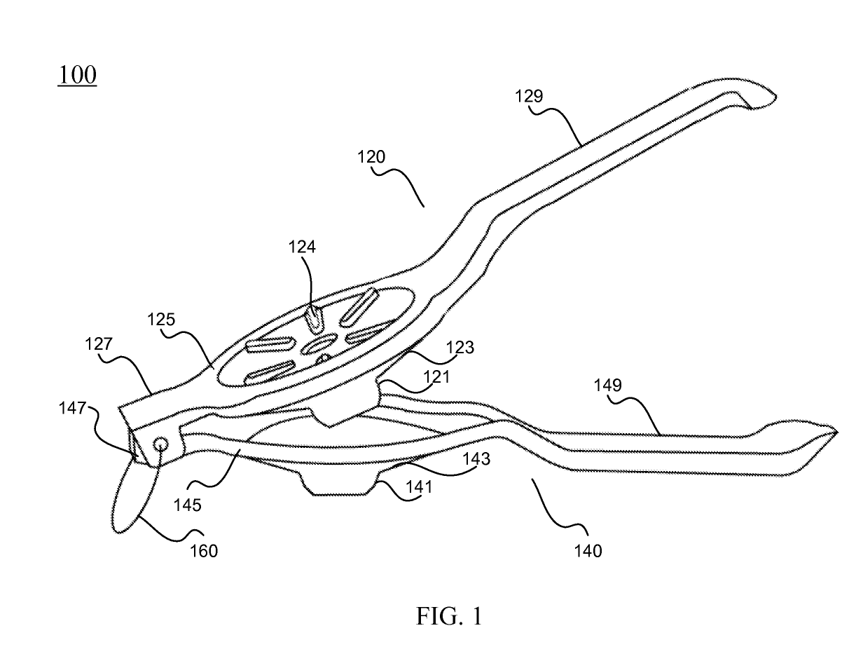

The description will be made as to the embodiments of the invention in conjunction with the accompanying drawings in FIGS. 1-5B. In accordance with the purposes of this invention, as embodied and broadly described herein, this invention, in one aspect, relates to a fruit press having an elevated outer ring, such that during operation, the skin of the fruit spread out instead of roll in, and maximum juice is extracted with minimum efforts.

FIGS. 1-3D show a manual fruit press according to certain embodiments of the present invention. As shown in FIG. 1, the fruit press 100 includes a top plate 120, a base plate 140 disposed below the top plate 120, and a pivot mechanism 160 that connects the top plate 120 and the base plate 140 together, such that the top plate 120 and the base plate 140 are rotatable relative to each other around the pivot mechanism 160. The top plate 120 includes a press portion 121, a first middle portion 123, a first rim 125, a first pivot portion 127, and a first handle portion 129. The base plate 140 includes a receive portion 141, a second middle portion 143, a second rim 145, a second pivot portion 147, and a second handle portion 149. At operation, a fruit such as a lemon, a lime, an orange, or the like may be cut in half, and one of the half fruits is inserted between the top plate 120 and the base plate 140 with the cutting surface facing downward toward the receive portion 141. The top plate 120 is pressed toward the base plate 140 through the handle portions 129 and 149 of the fruit press 100, to squeeze juice from the half fruit.

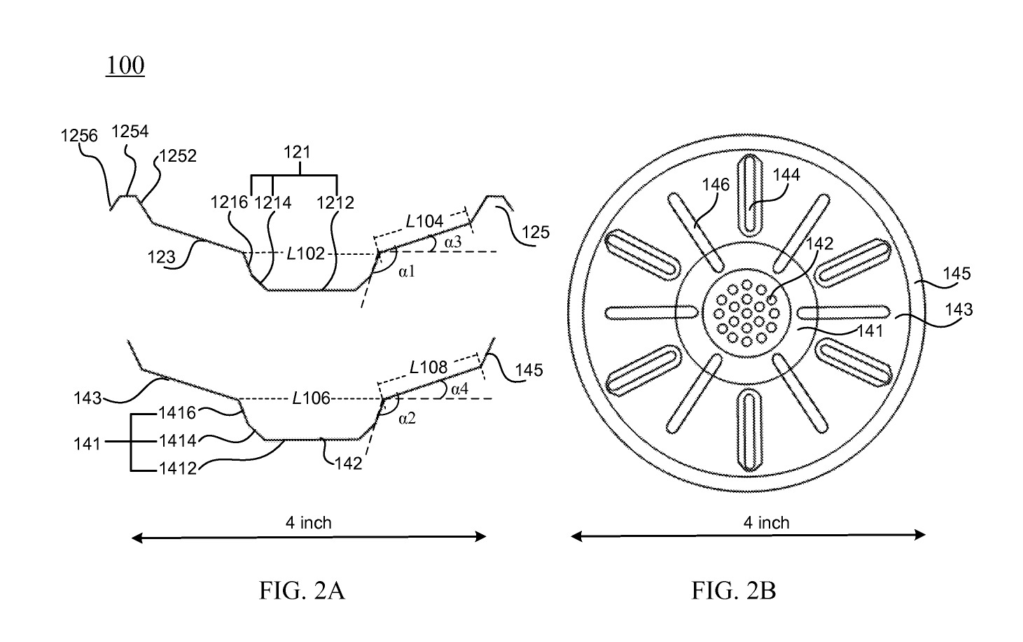

FIG. 2A shows sectional side view of the fruit press 100, without showing the pivot portions 127 and 147, and without showing the handle portions 129 and 149. The press portion 121 is configured to press the half fruit (or part of a fruit, or a whole fruit when suitable) that is placed between the top plate 120 and the base plate 140. In certain embodiments, viewed from the side, the press portion 121 includes several curved sections, and each of the curved sections may have a different curvature. Each of the curved sections, which may be a part of a spherical surface, can be imagined as a continuous structure formed by the part shown in FIG. 2A through a 180 degree rotation. As shown in FIG. 2A, the press portion 121 include a first section 1212, a second section 1214, and a third section 1216. The first section 1212 or the bottom part of the press portion 121 is flat or slightly curved upwards. The second section 1214 extends upward from the first section 1212 and surrounds the first section 1212. When viewing from the sectional view of FIG. 2A, the second section 1214 in straight. In other embodiments, the second section 1214 may also be slightly curved downward or upward. The third section 1216 extends upward from the second section 1214 and surrounds the second section 1214. When viewing from the sectional view of FIG. 2A, the third section 1216 in straight. In other embodiments, the third section 1216 may also be slightly curved upward or downward. In one embodiment, the curvature of the third section 1216 is greater than the curvature of the first section 1212 or the curvature of the second section 1214. That is to say, the first section 1212 and the second section 1214 are more flat than the third section 1216. In certain embodiments, the press portion 121 may only include the first section 1212 and the third section 1216, and the second section 1214 is only a smooth connection between the first section 1212 and the third section 1216. In certain embodiments, the press portion 121 may also include more than three sections. In certain embodiments, the press portion 121 may be a perfect semi-sphere, or part of a sphere that is larger than a semi-sphere or smaller than a semi-sphere. In one embodiment, the press portion 121 is smaller than a semi-sphere. The press portion 121 basically has a concave inner surface and a convex outer surface. The surfaces of the spherical press portion 121 may be smooth, or may have bumps or protrusions. In certain embodiments, the convex outer surface of the press portion 121 has multiple protrusions to enhance the pressing effect. In certain embodiments, the curvature of the first section 1212 faces downward, so as to form a recess at the bottom surface of the press portion 121, and when the half fruit is placed between the top plate 120 and the base plate 140 with the cutting surface facing downward, the top of that half fruit is received in the recess, so as to stabilize the half fruit on site.

As shown in FIG. 2A, the shape and size of the press portion 121 corresponds to the shape and size of the receive portion 141, and the size of the press portion 121 is slightly smaller than that of the receive portion 141. In other embodiments, the size of the press portion 121 may be substantially the same as the size of the receive portion 141. The length L102 cross the center of the top circle of the press portion 121 (diameter of the top horizontal circle), as shown in the sectional side view of FIG. 2A, is in a range of about 0.5-2 inch. In certain embodiments, the length L102 is in a range of 1-1.5 inch. In one embodiment, the length L102 is about 1.25 inch. In certain embodiments, the top circumference of the press portion 121 may not be a perfect circle, it may also have a shape of an eclipse, where the long axis of the eclipse has a length of L102. In certain embodiment, when the press portion 121 has a perfect semi-spherical shape, the length L102 is the diameter of the semi-spherical shaped press portion 121. In certain embodiments, when the press portion 121 is a sphere smaller than the semi-sphere, the diameter of the sphere of the press portion 121 is greater than the length L102.

The first middle portion (or outer ring of the top plate) 123 surrounds the press portion 121, and has an elevated, slanted ring shaped structure. The bottom circumference of the first middle portion 123 is the top circumference of the press portion 121, and the top circumference of the first middle portion 123 is the bottom circumference of the first rim 125. The first middle portion 123 has an upper surface facing upward, and a bottom surface facing and corresponding to the second middle portion 143 of the base plate 140. In certain embodiments, both the upper surface and the bottom surface of the slanted ring shaped first middle portion 123 are smooth, and the side view of the first middle portion 123 as shown in FIG. 2A is thus two straight lines. In other embodiments, at least one of the upper surface and the bottom surface of the first middle portion 123 has a surface with bumps or protrusions, or/and ridges. In one embodiment, the first middle portion 123 has multiple first ridges 124 protruding upwards, which may enhance fixing of the half fruit by cooperating with the ridges on the bottom plate 140. In other words, the bottom surface of the first middle portion 123 is depressed upward to form the first ridges 124, or the top surface of the first middle portion 123 is projected upward to form the first ridges 124. In one embodiment, the number of the first ridges 124 is six. In certain embodiment, the first ridges 124 may or may not extend from the inner circumference of the first middle portion 123 (or the outer circumference of the press portion 121), but may extend to the outer circumference (or top circle) of the first middle portion 123. In other words, there is a small distance between the inner end of the first ridges 124 to the inner circumference of the first middle portion 123. In certain embodiments, the first middle portion 123 may also include several curved sections with different curvatures. In certain embodiments, as shown in the sectional side view of FIG. 2A, the first middle portion 123 forms an obtuse angle α1 with a tangent of the press portion 121, where the tangent is at the connecting portion of the first middle portion 123 and the press portion 121. In certain embodiments, the angle α1 is in a range of 100°-180°. In certain embodiments, the angle α1 is in a range of 130°-170°. In certain embodiments, the angle α1 is about 150°. In other words, the first middle portion 123 forms an acute angle α3 with the horizontal line, such that the first middle portion 123 extends outward and upward from the press portion 121, that is, elevated from the horizontal line. In certain embodiments, the angle α3 is in a range of 5°-45°. In certain embodiments, the angle α3 is in a range of 10°-30°. In certain embodiments, the angle α3 is about 20°.

The shape and size of the first middle portion 123 correspond to the shape and size of the second middle portion 143, and the size of the first middle portion 123 is substantially the same as the size of the second middle portion 143. In certain embodiments, the size of the first middle portion 123 is slightly smaller or larger than the second middle portion 143. In certain embodiments, the slanted ring shaped first middle portion 123 has an inner diameter in a range of 0.5-2 inch, and an outer diameter in a range of 2.5-5 inch. In certain embodiments, the ring shaped first middle portion 123 has the inner diameter in a range of 1-1.5 inch, and the outer diameter in arrange of 3-4 inch. In one embodiment, the slanted ring shaped first middle portion 123 has the inner diameter of about 1.25 inch, and the outer diameter of about 3.5 inch. In certain embodiments, the length of the slanted ring shaped structure in the radial direction L104, that is, the distance from the bottom circle of the first middle portion 123 to the top circle of the first middle portion 123, is in a range of 0.5-2.0 inch. In certain embodiment, the length L104 of the slanted ring shaped first middle portion 123 in the radial direction is in a range of 1.0-1.5. In one embodiment, the length L104 of the slanted ring shaped first middle portion 123 in the radial direction is about 1.25 inch. During operation, the skin of the half fruit spreads to the space between the first middle portion 123 and the second middle portion 143, and the first middle portion 123 having the length of L104 is configured to hold the spread fruit skin in place.

The first rim 125 surrounds the first middle portion 123. As shown in FIG. 2A, the first rim 125 includes a first rim portion 1252 extending outward and upward from the outer circumference of the first middle portion 123, a second rim portion 1254 extending outward and horizontally from the first rim portion 1252, and a third rim portion 1256 extending outward and downward from the second rim portion 1254. In combination of the rim portions 1252, 1254 and 1256, the first rim 125 forms ring shaped structure that defines a groove facing downwards, such that the corresponding second rim 145 is receivable in the groove defined by the first rim 125. In certain embodiments, the first rim 125 may not include a first rim portion 1252, and the horizontal second rim portion 1254 extends directly from the outer circumference of the first middle portion 123. In certain embodiments, the third rim portion 1256 may extends directly downward from the second rim portion 1254, and perpendicular to the second rim portion 1254. In one embodiment, the third rim portion 1256 forms an acute angle with the second rim portion 1254 in the sectional view. The diameter of the first rim portion 1252, the second rim portion 1254 and the third rim portion 1256 may differentiate from each other by a small number, such that the groove defined by the first rim 125 is small, as long as the groove is large enough to receive the second rim 145. In certain embodiments, the inner diameter and outer diameter of the first rim portion 1252 is slightly less than that of the second rim 145, and the inner diameter and outer diameter of the third rim portion 1256 is slightly greater than that of the second rim 145, such that the second rim 145 is receivable between the first rim portion 1252 and the third rim portion 1256, and in contact with the second rim portion 1254. In certain embodiments, the diameters of the first rim portion 125, including the inner diameter of the first rim portion 1252, the outer diameter of the first rim portion 1252 (the inner diameter of the second rim portion 1254), the inner diameter of the third rim portion 1256 (the outer diameter of the second rim portion 1252), and the outer diameter of the third rim portion 1256, are in a range of 3-5 inch. In certain embodiments, the diameters of the first rim 125 are in a range of 3.5-4.5 inch. In one embodiment, the diameters of the first rim 125 are about 4 inch. In certain embodiments, the first rim portion 1252, the second rim portion 1254 and the third rim portion 1256 may not form straight angles between each other. Instead, the first rim portion 1252, the second rim portion 1254 and the third rim portion 1256 may integrally have a smoothly curved surface, such as part of a spherical surface, or each of the rim portions 1252, 1254 and 1256 has a respective curvature, and they are continuously and smoothly connected.

The first pivot portion 127 extends from a first direction of the first rim 125, corresponds to the second pivot portion 147 of the base plate 140, and is pivotally connected to the second pivot portion 147 through the pivot mechanism 160.

The first handle portion 129 extends from a second direction of the first rim 125, and corresponds to the second handle 149 of the base plate 140. In certain embodiments, the second direction is opposite to the first direction.

The first pivot portion 127 and the first handle portion 129 extend from the first rim 125, and have the structures continues from the second rim portion 1254 and the third rim portion 1256. An edge of the top plate 120 is continuously formed to include the third rim portion 1256 and parts of the first pivot portion 127 and the first handle portion 129 that are extended from the third rim portion 1256. The edge faces downward, and forms an angel with the second rim portion 1252 or other parts of the first pivot portion 127 or the first handle portion 129. The edge of the top plate 120, when in operation, is able to prevent leak of juice from the edge of the top plate 120.

The receive portion 141 is configured to receive the half fruit (or part of a fruit, or a whole fruit when suitable) that is placed between the top plate 120 and the base plate 140, and press the half fruit together with the press portion 121, to squeeze the juice out.

In certain embodiments, the size and shape of the receive portion 141 is complimentary to the size and shape of the press portion 121. In certain embodiments, viewed from the side, the receive portion 141 includes several sections that are flat or curved, and each of the sections may have a different curvature. Each of the sections, which may be a part of a spherical surface, can be imagined as a continuous structure formed by the part shown in FIG. 2A through a 180 degree rotation. As shown in FIG. 2A, the receive portion 141 include a fourth section 1412, a fifth section 1414, and a sixth section 1416. The fourth section or the bottom part of the receive portion 141 is flat or slightly curved upwards. The fifth curved section 1414 extends upward from the fourth section 1412 and surrounds the fourth section 1412. When viewing from the sectional view of FIG. 2A, the fifth section 1414 is straight. In other embodiments, the fifth section 1414 may also be slightly curved downward or upward. The sixth section 1416 extends upward from the fifth section 1414 and surrounds the fifth section 1414. When viewing from the sectional view of FIG. 2A, the sixth section 1416 is straight. In other embodiments, the sixth section 1216 may also be slightly curved upward or downward. In one embodiment, the curvature of the sixth section 1416 is greater than the curvature of the fourth section 1412 or the curvature of the fifth section 1414. That is to say, the fourth section 1412 and the fifth section 1414 are more flat than the sixth section 1216. In certain embodiments, the receive portion 141 may only include the fourth section 1412 and the sixth section 1416, and the fifth section 1414 is only a smooth connection between the fourth section 1412 and the sixth section 1416. In certain embodiments, the receive portion 141 may also include more than three sections. In certain embodiments, the receive portion 141 may be a perfect semi-sphere, or part of a sphere that is larger than a semi-sphere or smaller than a semi-sphere. In one embodiment, the receive portion 141 is smaller than a semi-sphere. In certain embodiments, the receive portion 141 basically has a concave inner surface and a convex outer surface. The surfaces of the spherical receive portion 141 may be smooth, or may have bumps or protrusions. In certain embodiments, the concave inner surface of the receive portion 141 has multiple protrusions to enhance the pressing effect.

As shown in FIG. 2A, the shape and size of the receive portion 141 corresponds to the shape and size of the press portion 121, and the size of the receive portion 141 is slightly larger than that of the press portion 121. In other embodiments, the size of the receive portion 141 may be substantially the same as the size of the press portion 121. The length L106 cross the center of the top circle of the receive portion 141 (diameter of the top horizontal circle), as shown in the sectional view of FIG. 2A, is in a range of about 0.5-2.5 inch. In certain embodiments, the length L106 is in a range of 1-2 inch. In one embodiment, the length L106 is about 1.5 inch. In certain embodiments, the top circumference of the receive portion 141 may not be a perfect circle, it may also have a shape of an eclipse, where the long axis of the eclipse has a length of L106. In certain embodiment, when the receive portion 141 has a perfect semi-spherical shape, the length L106 is the diameter of the semi-spherical shaped receive portion 141. In certain embodiments, when the receive portion 141 is a sphere smaller than the semi-sphere, the diameter of the sphere of the receive portion 141 is greater than the length L106. In certain embodiments, in order to let the squeezed juice out from the receive portion 141 to a container placed under the fruit press 100, multiple through holes 142 are disposed at the bottom of the receive portion 141. From the sectional side view as shown in FIGS. 2A and 2B, the multiple holes 142 are located within the fourth section 1412 of the receive portion 141. The size and number of the through holes 142 may be determined according to the size of the fourth section 1412. In certain embodiments, the number of the through holes 142 at the bottom of the receive portion 141 is in a range of 4-30. In one embodiment, the number of the through holes 142 are 12, which are aligned in four rows having 2, 4, 4, 2 holes respectively, or with 4 holes aligned in an inner circle forming a square shape, and 8-12 holes aligned in an outer circle surrounding the inner circle of four holes. In one embodiment, the number of the through holes 142 is 18, which are aligned in 6 rows having 2, 3, 4, 4, 3, 2 holes respectively. In one embodiment, the number of the through holes 142 is 14, which are aligned with an inner circle of 4 holes and an outer circle of 10 holes surrounding the inner circle.

The second middle portion (or outer ring of the base plate) 143 surrounds the receive portion 141, and has an elevated, slanted ring shaped structure. The bottom circumference of the second middle portion 143 is the top circumference of the receive portion 141, and the top circumference of the second middle portion 143 is the bottom circumference of the second rim 145. The second middle portion 143 has an upper surface facing upward and facing and corresponding to the first middle portion 123 of the top plate 120, and a bottom surface facing downward. In certain embodiments, both the upper surface and the bottom surface of the ring shaped second middle portion 143 are smooth, and the side view of the second middle portion 143 as shown in FIG. 2A is thus two straight lines. In other embodiments, at least one of the upper surface and the bottom surface of the second middle portion 143 has a surface with bumps or protrusions, or/and ridges. In one embodiment, as shown in FIG. 2B, the second middle portion 143 has multiple second ridges 144 protruding upward, which may enhance fixing of the half fruit being pressed. In other words, the bottom surface of the second middle portion 143 is depressed upward to form the second ridges 144, or the top surface of the second middle portion 143 is projected upward to form the second ridges 144. In one embodiment, the number of the second ridges 144 is six. In certain embodiment, the second ridges 144 may extend from the inner circumference of the second middle portion 143 (or the outer circumference of the receive portion 141), but may or may not extend to the outer circumference (or top circle) of the second middle portion 143. In other words, there is a small distance between the outer end of the second ridges 144 to the outer circumference of the second middle portion 143. The second ridges 144 correspond to the first ridges 124 one by one. When the top plate 120 and the bottom plate 140 are closed toward each other, the second ridges 144 at the upper surface of the bottom plate 140 is at least partially received in the groove of the first ridges 124 at the bottom surface of the top plate 120. In certain embodiments, the second middle portion 143 may further include multiple channels 146. In certain embodiments, the multiple channels 146 are formed by simply press part of the second middle portion 143 and the fifth section 1414 and the sixth section 1416 of the receive portion 141. In certain embodiment, each of the channels 146 is disposed between two adjacent second ridges 144. The outer end of each of the channels 146 may not extend outward as farther as the outer end of the second ridges 144, while the inner end of each of the channels 146 may extend inward farther than the inner end of the second ridges 144. In one embodiment, the inner end of each of the channels 146 extends to the connection part between the fourth section 1412 and the fifth section 1414. In certain embodiments, the second middle portion 143 may also include several curved sections with different curvatures. In certain embodiments, as shown in the sectional side view of FIG. 2A, the second middle portion 143 forms an obtuse angle α2 with a tangent of the receive portion 141, where the tangent is at the connecting portion of the second middle portion 143 and the receive portion 141. In certain embodiments, the angle α2 is in a range of 95°-170°. In certain embodiments, the angle α2 is in a range of 110°-150°. In certain embodiments, the angle α2 is about 130°. In other words, the second middle portion 143 forms an acute angle α4 with the horizontal line, such that the second middle portion 143 is extended outward and upward from the receive portion 141. In certain embodiments, the angle α4 is in a range of 5°-45°. In certain embodiments, the angle α4 is in a range of 15°-35°. In certain embodiments, the angle α4 is about 25°.

The shape and size of the second middle portion 143 correspond to the shape and size of the first middle portion 123. As described above, the size of the first middle portion 123 is substantially the same as the size of the second middle portion 143. In certain embodiments, since the receive portion 141 is slightly larger than the press portion 121, the size of the second middle portion 143 may be slightly smaller than the first middle portion 123. In certain embodiments, the slanted ring shaped second middle portion 143 has an inner diameter in a range of 0.5-2.5 inch, and an outer diameter in a range of 3-4.5 inch. In certain embodiments, the ring shaped second middle portion 143 has the inner diameter in a range of 1-2 inch, and the outer diameter in arrange of 3.25-4.25 inch. In one embodiment, the ring shaped second middle portion 143 has the inner diameter of about 1.5 inch, and the outer diameter of about 3.75 inch. In certain embodiments, the length of the slanted ring shaped structure in the radial direction L108, that is, the distance from the bottom circle of the second middle portion 143 to the top circle of the second middle portion 143, is in a range of 0.5-2.0 inch. In certain embodiment, the length L108 of the slanted ring shaped second middle portion 143 in the radial direction is in a range of 1.0-1.5. In one embodiment, the length L108 of the slanted ring shaped second middle portion 143 in the radial direction is about 1.25 inch. During operation, the skin of the half fruit spreads to the space between the first middle portion 123 and the second middle portion 143, and the lengths L104 and L108 of the first middle portion 123 and the second middle portion 143 are long enough to hold the spread fruit skin in place.

The second rim 145 surrounds the second middle portion 143. As shown in FIG. 2A, the second rim 145 extends outward and upward from the outer circumference of the second middle portion 143. The diameter of the second rim 145 is substantially the same as the diameter of the groove defined by the first rim 125, such that the second rim 145 is receivable by the groove. In certain embodiments, the diameters of the second rim portion 145, including the inner diameter and the outer diameter, are in a range of 3-5 inch. In certain embodiments, the diameters of the second rim 145 are in a range of 3.5-4.5 inch. In one embodiments, the diameters of the second rim 145 are about 4 inch. In certain embodiments, the second rim 145 may form an obtuse angle with the second middle portion 143. In certain embodiment, the second rim 145 may be smoothly curved from the top circumference of the second middle portion 143.

The second pivot portion 147 extends from a first direction of the second rim 145, corresponds to the first pivot portion 127 of the top plate 120, and is pivotally connected to the first pivot portion 127 through the pivot mechanism 160.

The second handle portion 149 extends from a second direction of the second rim 145, and corresponds to the first handle portion 129 of the top plate 120. In certain embodiments, the second direction is opposite to the first direction.

The second pivot portion 147 and the second handle portion 149 extend from the second rim 145 continuously. An edge of the base plate 140 is continuously formed to includes the second rim 145 and parts from the second pivot portion 127 and the second handle portion 149 that are extended from the second rim 145. The edge faces upward, and forms an angel with the second rim 145 or other parts of the second pivot portion 127 and the second handle portion 149. The edge of the base plate 140, collaborated with the edge of the top plate 120 in operation, is able to prevent leak of juice. In certain embodiments, the edge of the base plate 140 has a size slightly smaller than the size of the edge of the top plate 120, such that in operation, the edge of the top plate 120 fits well from outside of the edge of the base plate 140. In one embodiments, the edge of the base plate 140 may also have a size slightly greater than the size of the edge of the top plate 120.

The pivot mechanism 160 is configured to connect the top plate 120 and the base plate 140, and to make the top plate 120 and the base plate 140 rotatable relative to each other. In one embodiment, the first pivot portion 127 and the second pivot portion 147 each have two through holes respectively, and the pivot mechanism 160 is a pivotal rod that passes through the through holes of the first and second pivot portions 127 and 147, to rotatablely fix the top plate 120 to the base plate 140. In other embodiments, the pivot mechanism 160 may also be other type of structures, as long as the top plat 120 and the base plate 140 are fixed and rotatable relative to each other. In certain embodiment, the pivotal rod has a ring shaped structure with a notch, and two ends of the pivotal rod has small distance at the notch. One end of the pivotal rod is inserted in one side of the fruit press 100 passing through one through hole of the second pivot portion 147 and one corresponding through hole of the first pivot portion 127. The other end of the pivotal rod is inserted in the other side of the fruit press 100 passing through the other through hole of the second pivot portion 147 and the other corresponding through hole of the first pivot portion 127. The ring shaped pivotal rod can be used for hanging the fruit press 100 on a hook or a holder to save storage space. In certain embodiments, the pivot mechanism 160 further include a stop structure, such that the largest angle that the top plate 120 and the base plate 140 can be opened is limited by the stop structure. In certain embodiments, the limiting of the opening of the top plate 120 and the base plate 140 is achieved by urging an end of a plate portion of the second pivot portion 147 against an end of a plate portion of the first pivot portion 127. In certain embodiments, the largest angle that the top plate 120 and the base plate 140 can be opened is about 80°-120°. In one embodiment, the largest open angle formed by the top plate 120 and the base plate 140 is about 100°. In other words, the top plate 120 and the base plate 140 are rotatable relative to each other, and the rotatable angle is in a range of from 0° to about 80-120°.

The fruit press 100 may further include a container (not shown) for receiving the juice generated by squeezing the half fruit by the top plate 120 and the base plate 140. In certain embodiments, the opening of the container and the bottom of the base plate 140 is configured to fit with each other, so as to improve stability during operation and prevent leaking of juice. In one example, the receive portion 141 or part of the receive portion 141 is configured to be inserted into the opening of the container. In another example, the press 100 is hold by the user above a large opening of the container, and the press 100 does not need to touch the container. In certain embodiments, the fruit press 100 can be used with varieties of containers such as a cup, a bowl, a flask, etc., that are normally used in everyday life.

In certain embodiments, the fruit press 100 further include a fixing mechanism for fixing the base plate 140 to the container. In one embodiment, the base plate 140 is screwed on the container.

In certain embodiments, the fruit press 100 is made of a material that is safe for dishwasher or manual washing. In one embodiment, the fruit press 100 is made of stainless steel. In one embodiment, the fruit press 100 is made of polymers or plastics that has a high hardness for pressing the half fruit.

In certain embodiments, the top plate 120 of the fruit press 100 is integrally formed, the base plate 140 of the fruit press 100 is integrally formed, and the top plate 120 and the base plate 140 are then assembled through the pivot mechanism 160. In one embodiment, the top plate 120 is made by blanking using one stainless steel plate, the base plate 140 is mad by blanking using one stainless steel plate, and the top plate 120 and the base plate 140 may or may not be formed from the same stainless steel plate.

In certain embodiments, each of the top plate 120 and the base plate 140 has substantially the same thickness. In certain embodiments, the top plate 120 has slightly different thickness from the base plate 140. In certain embodiments, different portions of the top plate 120 or different portions of the base plate 140 may have different thickness. In one embodiment, each of the top plate 120 and the base plate 140 may have substantially the same thickness, while a few portions have increased thickness for increased strength. For example, the bottom portion 1216 of the top plate 120, the bottom portion 1416 of the base plate 140, or the pivot portions of the top plate 120 and the bottom plate 140 may have enhanced strength by increasing thickness or other means. In certain embodiments, the thickness of the top plate and the base plate is in a range of 0.02-0.1 inch. In certain embodiments, the thickness of the top plate and the base plate is in a range of 0.04-0.08 inch. In one embodiments, the thickness of the top plate and the base plate is about 0.06 inch.

In certain embodiments, the total length of the fruit press 100, from the pivot portions to the handle portions, is in a range of 6-15 inch. In certain embodiments, the total length of the fruit press 100 is in a range of 9-13 inch. In one embodiment, the total length of the fruit press 100 is about 11 inch.

In certain embodiments, the fruit press 100 is a manual fruit press. In certain embodiments, the fruit press 100 may further include a motor and other necessary components to form an electronic fruit press.

At operation, a fruit, such as an orange, a lime, a lemon, or the like, is cut in half, or other type of pieces with at least a skin side and a flesh side. The half fruit is placed between the top plate 120 and the base plate 140, with the cut surface (or the exposed surface or the flesh side) facing the receive portion 141, and the top surface (or the unexposed surface or the skin side) facing the press portion 121. The top plate 120 and the base plate 140 may be moved reciprocally to press the half fruit. The skin of the half fruit, when being pressed, moves toward the space between the first middle portion 123 and the second middle portion 143. The first ridges 124 and the second ridges 144 helps to squeeze and spread fix the fruit skin. The channels 146 helps the juice flows down from between the first middle portion 123 and the middle portion 143 down to the receive portion 141. The squeezed juice is received by the receive portion 141, and then passes the through holes 142, toward the container (not shown) under the base plate 140.

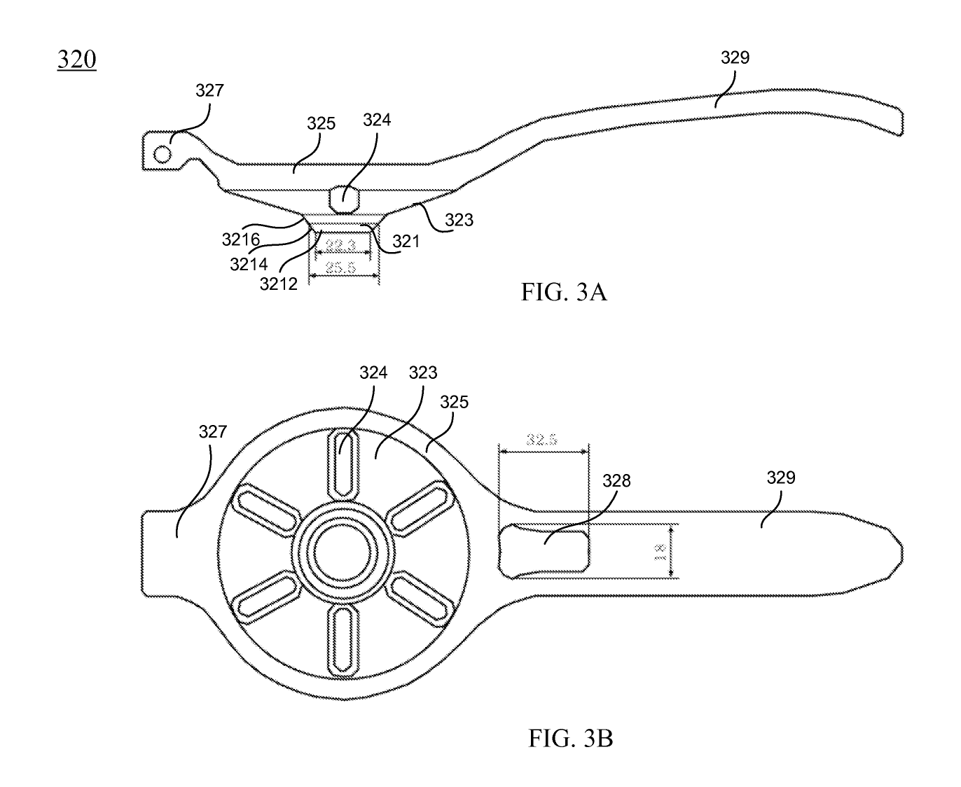

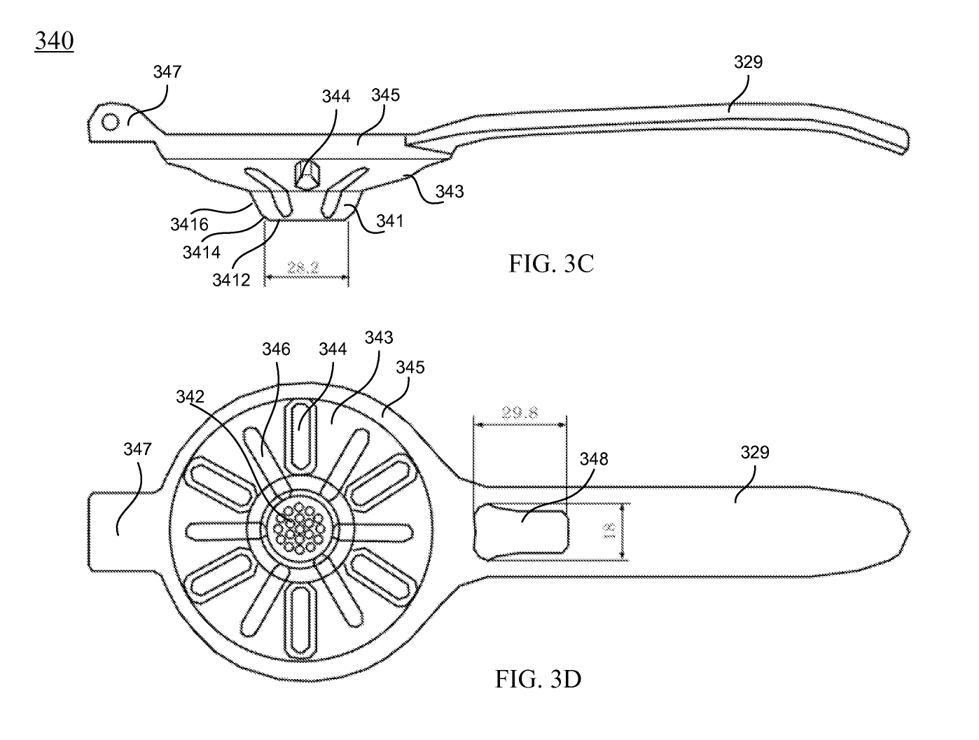

FIGS. 3A-3D shows one example of a fruit press according to one embodiment of the present invention, where FIG. 3A shows a schematic sectional side view of a top plate 320 of the fruit press 300, FIG. 3B shows a schematic top view of the top plate 320 of FIG. 3A, FIG. 3C shows a schematic sectional side view of a base plate 340 of the fruit press 300, and FIG. 3D shows a schematic top view of the base plate 340 of FIG. 3C.

As shown in FIGS. 3A-3B, the top plate 320 includes a press portion 321, a first middle portion 323, a first rim 325, a first pivot portion 327, and a first handle portion 329. The press portion 321 includes a first section 3212, a second section 3214, and a third section 3216. A diameter of the first or flat section 3212 is about 22.3 mm. A diameter at the top of the second section 3214 is about 25.5 mm. A top concave 328 is located around the connection part between the first rim 325 and the first handle portion 329. The length of the top concave 328 is about 32.5 mm, and the width of the top concave 328 is about 18 mm. Six first (top) ridges 324 are symmetrically located at the first middle portion 323. In one embodiment, the first ridges 324 are embossed on the top plate 320.

As shown in FIGS. 3C-3D, the base plate 340 includes a receive portion 341, a second middle portion 343, a second rim 345, a second pivot portion 347, and a second handle portion 349. The receive portion 341 includes a fourth section 3412, a fifth section 3414, and a sixth section 3416. A diameter of the fourth or flat section 3412 is about 28.2 mm. A base concave 348 is located around the connection part between the second rim 345 and the second handle portion 349. The length of the base concave 348 is about 29.8 mm, and the width of the base concave 348 is about 18 mm.

Six second (base) ridges 344 are symmetrically located at the second middle portion 343, and correspond to the six first ridges 324 respectively. In one embodiment, the second ridges 344 are embossed on the base plate 340. In certain embodiments, the second ridges 344 are big straight embossed ridges bigger than the first ridges 324. The base ridges 344 are used for cutting into the skin of the fruit, and the skin of the fruit spread out easily after the cutting by the second ridges 344.

Six channels 346 are symmetrically located at the second middle portion 343. Each of the six channels 346 is located between two adjacent second ridges 344. The bottom end of each channel 346 extends to the fifth curved section 3414 or the connection part between the fourth curved section 3412 and the sixth curved section 3416, and the channels 346 are debossed (lower than surface), such that in operation, the juice spreads between the top plate 320 and the base plate 340 is easily flew down toward the fourth or flat section 3412. Multiple holes 342 are located at the fourth or flat section 3412, and the juice flows through those holes 342 toward a container underneath.

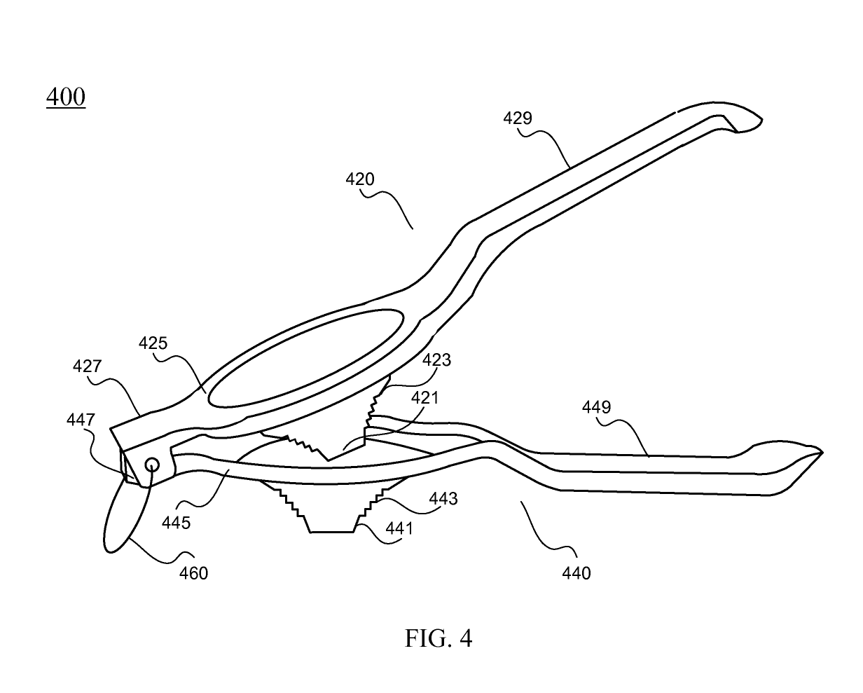

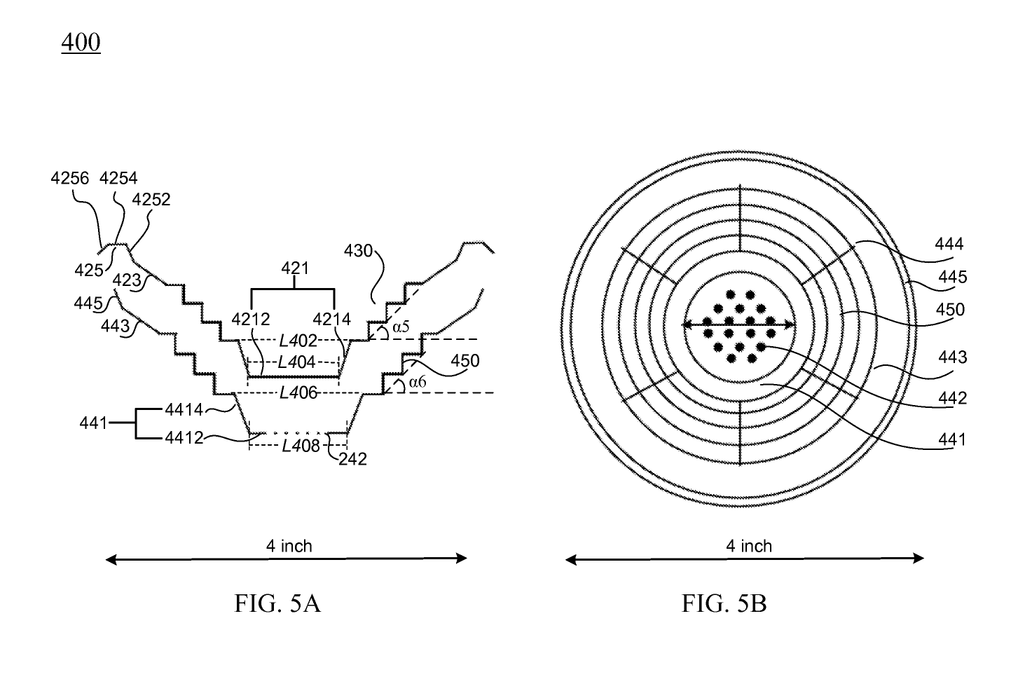

In another aspect, the present invention relates to a fruit press having an elevated outer ring and stepped structures on the outer ring. FIGS. 4, 5A and 5B show a manual fruit press according to certain embodiments of the present invention. In this embodiment, the structure of the fruit press 400 is similar to the fruit press 100. The differences include, among other things, that the middle portions (outer rings) of the top plate 420 and the base plate 440 have stepped structures.

As shown in FIG. 4, the fruit press 400 includes a top plate 420, a base plate 440 disposed below the top plate 420, and a pivot mechanism 460 that connects the top plate 420 and the base plate 440 together, such that the top plate 420 and the base plate 440 are rotatable relative to each other around the pivot mechanism 460. The top plate 420 includes a press portion 421, a first middle portion 423, a first rim 425, a first pivot portion 427, and a first handle portion 429. The base plate 440 includes a receive portion 441, a second middle portion 443, a second rim 445, a second pivot portion 447, and a second handle portion 449. At operation, a fruit such as a lemon, a lime, an orange, or the like is cut in half, and one of the half fruits is inserted between the top plate 420 and the base plate 440 with the cutting surface facing downward toward the receive portion 441. The top plate 420 is pressed toward the base plate 440 through the handle portions 429 and 449 of the fruit press 400, to squeeze juice from the half fruit.

FIG. 5A shows sectional side view of the fruit press 400, without showing the pivot portions 427 and 447, and without showing the handle portions 429 and 449. As shown in FIG. 5A, the press portion 421 has a flat, circular bottom portion 4212 and a slanted ring shaped side portion 4214 extending upward and outward from the circumference of the bottom portion 4212. In certain embodiments, the bottom portion 4212 may also has an elliptical shape or other shapes. The surfaces of the press portion 421 may be smooth, or may have bumps or protrusions. In certain embodiments, the outer surface of the bottom portion 4212, which faces the receive portion 441 of the base plate 440, has multiple protrusions to enhance the pressing effect. In certain embodiments, the bottom portion 4212 has a recess in the center of the outer surface, such that when the half fruit is placed between the top plate 420 and the base plate 440 with the cutting surface facing downward, the top of that half fruit is received in the recess, so as to stabilize the half fruit on site.

As shown in FIG. 5A, the shape and size of the press portion 421 corresponds to the shape and size of the receive portion 441. In certain embodiments, the size of the press portion 421 is slightly smaller than that of the receive portion 441. In certain embodiments, the length L404 of the bottom portion 4212 (or the diameter of the bottom portion 4212 when it is circular), or the length or diameter at the bottom of the side portion 4214, is in a range of about 1-1.5 inch. In one embodiment, the length L404 of the bottom portion 4222 is about 1.25 inch. The length L402, or the diameter at the top of the side portion 4214, is in a range of about 0.5-3 inch. In certain embodiments, the length L402 is in a range of 1-2 inch. In one embodiment, the length L402 is about 1.5 inch.

The first middle portion 423 (or outer ring) surrounds the press portion 421, and has an elevated, slanted ring shaped structure. The bottom circumference of the first middle portion 423 is the circumference (outer circumference) of the press portion 421, and the top circumference of the first middle portion 423 is the bottom circumference of the first rim 425. In this embodiment, the first middle portion 423 include multiple stepped structures 430. Each of the stepped structures 430 may include a horizontal step and a vertical step forming a right angle, as shown in FIG. 5A. In certain embodiment, the two steps of each stepped structure 430 may not be horizontal and vertical respectively. Instead, the two steps of any one of the stepped structure 430 may be slanted. In one embodiment, two steps of at least one of the stepped structures 430 forms an obtuse angle, with the vertex of the obtuse angle pointing upward and inward of the top plate 420. In certain embodiments, the number of the stepped structures 430 is in a range of 1-8. In certain embodiments, the number of the stepped structures 424 is in a range of 2-6. In one embodiment, the number of the stepped structure 430 is 3. In certain embodiments, the stepped structures 430 may start from the outer circumference of the press portion 421, and extend to half or more than half of the first middle portion 423 along the radial direction. In certain embodiments, each of the stepped structures 430 has the same size. In certain embodiment, each stepped structure 430 has a horizontal length and a vertical length in a range of 0.05-0.5 inch. In certain embodiment, each stepped structure 430 has a horizontal length and a vertical length in a range of 0.1-0.3 inch. In certain embodiment, each stepped structure 430 has a horizontal length and a vertical length of about 0.2 inch. In certain embodiments, the stepped structures 430 may have different sizes. In other words, each stepped structure 430 may have a different size along the horizontal dimension and vertical dimension, or one stepped structure 430 has different sizes from the sizes of at least one of the other stepped structure 430.

In certain embodiments, the first middle portion 423 further includes multiple ridges 424 (not shown) at the bottom surface extending from the outer circumference of the press portion 421 radially, which may enhance fixing of the half fruit. The ridges 424 may have the same feature as the ridges 124 shown in FIG. 1 or the ridges 324 shown in FIG. 3B.

As shown in the sectional view of FIG. 5A, similar to that of the fruit press 100, the first middle portion 423 is elevated from inside outward, relative to the horizontal line. In certain embodiments, the first middle portion 423 forms an angle α5 with the horizontal line in a range of 10°-80°. In certain embodiments, the angle α5 is in a range of 30°-60°. In one embodiment, that angle α5 is about 45°.

The shape and size of the first middle portion 423 correspond to the shape and size of the second middle portion 443. The bottom circumference of the first middle portion 423 is the top circumference of the press portion 421, and the top circumference of the first middle portion 423 is the bottom circumference of the first rim 425. In certain embodiments, the size of the first middle portion 423 is substantially the same as the second middle portion 443. In other embodiments, the size of the first middle portion 423 is slightly smaller or larger than the size of the second middle portion 443. In certain embodiments, the ring shaped first middle portion 423 has an inner diameter in a range of 0.5-2.5 inch, and an outer diameter in a range of 2.5-5 inch. In certain embodiments, the ring shaped first middle portion 423 has the inner diameter in a range of 1.0-2.0 inch, and the outer diameter in arrange of 3.25-4.25 inch. In one embodiment, the ring shaped first middle portion 423 has the inner diameter of about 1.5 inch, and the outer diameter of about 3.75 inch.

The first rim 425 surrounds the first middle portion 423, includes a first rim portion 4252, a second rim portion 4254, and a third rim portion 4256, and has a structure similar to that of the first rim 125 of the top plate 120. The first pivot portion 427 and the first handle portion 429 have similar structures as that of the first pivot portion 127 and the first handle portion 129 of the top plate 120. An edge of the top plate 420 has a structure similar to that of the first top plate 120.

The receive portion 441 is configured to receive the half fruit (or part of a fruit, or a whole fruit under certain conditions) that is placed between the top plate 420 and the base plate 440, and press the half fruit together with the press portion 421, to squeeze juice from the fruit.

As shown in FIG. 5A, the shape and size of the receive portion 441 corresponds to the shape and size of the press portion 421. In certain embodiments, the size of the receive portion 441 is slightly larger than that of the press portion 421, such that during operation, the press portion 421 is receivable by the receive portion 441. In other embodiments, the size of the receive portion 441 may be substantially the same as the size of the press portion 421. In certain embodiments, the receive portion 441 includes a circular, flat, bottom portion 4412 and a slant, ring shaped portion 4414 extending upward and outward from the bottom portion 4412. The length L408 or diameter of the bottom portion 4412, as shown in the sectional side view of FIG. 5A and top view of FIG. 5B, is in a range of about 0.5-3 inch. In certain embodiments, the length L408 is in a range of 1-1.5 inch. In one embodiment, the length L408 is about 1.35 inch. The length L406, or outer diameter or top diameter of the slant, ring shaped portion 4414, is in a range of about 0.5-3 inch. In certain embodiments, the length L406 is in a range of 1-2 inch. In one embodiment, the length L406 is about 1.65 inch.

In certain embodiments, in order to let the squeezed juice out from the receive portion 441 to a container placed under the fruit press 400, multiple through holes 442 are disposed at the bottom of the receive portion 441. From the top view as shown in FIG. 5B, the multiple holes 442 are located within the bottom portion 4412. The size and number of the through holes 442 may be determined according to the size of bottom portion 4412. In certain embodiments, the number of the through holes 442 at the bottom portion 4412 is in a range of 4-30. In one embodiment, the number of the through holes 442 are 18, which are aligned in 6 row having 2, 3, 4, 4, 3, 2 holes respectively. In one embodiment, the number of the through holes 442 are 12, which are aligned in four rows having 2, 4, 4, 2 holes respectively, or with 4 holes aligned in an inner circle, and 8 holes aligned in an outer circle surrounding the inner circle. In one embodiment, the number of the through holes 442 is 14, which are aligned with an inner circle of 4 holes and an outer circle of 10 holes surrounding the inner circle.

The second middle portion 443 (or outer ring) surrounds the receive portion 441, and has an elevated, slanted ring shaped structure. The bottom circumference of the second middle portion 443 is the top circumference of the receive portion 441, and the top circumference of the second middle portion 443 is the bottom circumference of the second rim 445. In this embodiment, the second middle portion 443 include multiple stepped structures 450. Each of the stepped structures 450 may include a horizontal step and a vertical step forming a right angle. In certain embodiment, the two steps of each stepped structure 450 may not be horizontal and vertical respectively. Instead, any of the two steps of each stepped structure 450 may be slanted. In one embodiment, the two steps of at least one of the stepped structures 450 forms an obtuse angle, with the vertex of the obtuse angle pointing upward and inward of the base plate 440. In certain embodiments, the number of the stepped structures 450 is in a range of 1-8. In certain embodiments, the number of the stepped structures 450 is in a range of 2-6. In one embodiment, the number of the stepped structure 450 is 3. In certain embodiments, the stepped structures 450 may start from the outer circumference of the receive portion 441, and extend to half or more than half of the second middle portion 443 along the radial direction. In certain embodiments, each of the stepped structures 450 has the same size. In certain embodiment, each stepped structure 450 has a horizontal length and a vertical length in a range of 0.05-0.5 inch. In certain embodiment, each stepped structure 450 has a horizontal length and a vertical length in a range of 0.1-0.3 inch. In certain embodiment, each stepped structure 450 has a horizontal length and a vertical length of about 0.2 inch. In certain embodiments, the stepped structures 450 may have different sizes. In other words, each stepped structure 450 may have a different size along the horizontal dimension and vertical dimension, or one stepped structure 450 has different sizes from the sizes of at least one of the other stepped structure 450.

In certain embodiments, the second middle portion 443 further includes multiple ridges 444 at the upper surface extending from the outer circumference of the receive portion 441 radially to reach or pass the edge of the stepped structure 450 that is farthest from the receive portion 441. In certain embodiments, the number of the ridges 444 is in a range of 1-8. In certain embodiments, the number of the ridges 444 is six. The six ridges 444, together with the stepped structures 450, may help to keep the fruit skin in place, break the fruit skin for increasing surface area of the fruit so as to squeeze more juice, maintain position of the fruit in place, and prevent significant movement, especially the inward movement of the skin. In certain embodiments, since the stepped structure 450 itself has the above described function of positioning the fruit skin, breaking the fruit skin, and preventing skin movement, the multiple ridges 444 may not be necessary. In certain embodiments, the second middle portion 443 may further include multiple channels (not shown), which may have the similar structure as that of the multiple channels 146 of the press 100 or channels 346 of the press 300.

As shown in the sectional view of FIG. 5A, similar to that of the fruit press 100, the second middle portion 443 is elevated from inside outward, relative to the horizontal line. In certain embodiments, the second middle portion 443 forms an angle α6 with the horizontal line in a range off 10°-80°. In certain embodiments, the angle α6 is in a range of 30°-60°. In one embodiment, the angle α6 is about 45°.

The shape and size of the second middle portion 443 correspond to the shape and size of the first middle portion 423. In certain embodiments, since the receive portion 441 is slightly larger than the press portion 421, and the size of the second middle portion 443 may be slightly smaller than the first middle portion 423. In other embodiments, the size of the second middle portion 443 is substantially the same as the size of the first middle portion 423. In certain embodiments, the ring shaped second middle portion 443 has an inner diameter in a range of 0.5-2.5 inch, and an outer diameter in a range of 3-5 inch. In certain embodiments, the ring shaped second middle portion 443 has the inner diameter in a range of 1.0-2.0 inch, and the outer diameter in arrange of 3.5-4.5 inch. In one embodiment, the ring shaped second middle portion 443 has the inner diameter of about 1.65 inch, and the outer diameter of about 4 inch.

The second rim 445 surrounds the second middle portion 443, and has a structure similar to the second rim 145 of the first fruit press 100. The second pivot portion 447 and the second handle portion 449 have similar structures as the second pivot portion 147 and the second handle portion 149 of the first fruit press 100.

The pivot mechanism 460 is configured to make the top plate 420 and the base plate 440 rotatable relative to each other. In certain embodiments, the pivot mechanism 460 has the same structure as the pivot mechanism 160 of the fruit press 100.

As discussed above in related to the fruit press 100, the fruit press 400 may further include a container (not shown) for receiving the juice generated by squeezing the half fruit by the top plate 420 and the base plate 440. In certain embodiments, the opening of the container and the bottom of the base plate is configured to fit with each other, so as to improve stability during operation and prevent leaking of juice. In certain embodiments, the fruit press 400 can be used with varieties of containers such as a cup, a bowl, a flask, etc., that are normally used in everyday life.

In certain embodiments, the fruit press 400 further include a fixing mechanism for fixing the base plate 420 to the container. In one embodiment, the base plate 420 is screwed on the container.

In certain embodiments, the fruit press 400 is made of a material that is safe for dishwasher or manual washing. In one embodiment, the fruit press 400 is made of stainless steel. In one embodiment, the fruit press is made of polymers or plastics that has a high hardness for pressing the half fruit.

In certain embodiments, the top plate 420 of the fruit press 400 is integrally formed, the base plate 440 of the fruit press 400 is integrally formed, and the top plate 420 and the base plate 440 are then assembled through the pivot mechanism 460. In one embodiment, the top plate 420 is made by blanking using one stainless steel plate, and the base plate 140 is mad by blanking using one stainless steel plate.

In certain embodiments, each of the top plate 420 and the base plate 440 has substantially the same thickness. In certain embodiments, the top plate 420 and the base plate 440 may have different thicknesses. In certain embodiments, different portions of the top plate 420 or different portions of the base plate 440 may have different thickness. In one embodiment, each of the top plate 420 and the base plate 440 may have substantially the same thickness, while a few portions have increased thickness for increased strength. For example, the bottom portion 4212 of the top plate 420, the bottom portion 4412 of the base plate 440, or the pivot portions of the top plate 420 and the bottom plate 440 may have enhanced strength by increasing thickness or other means. In certain embodiments, the thickness of the top plate and the base plate is in a range of 0.02-0.1 inch. In certain embodiments, the thickness of the top plate and the base plate is in a range of 0.04-0.08 inch. In one embodiments, the thickness of the top plate and the base plate is about 0.06 inch.

In certain embodiments, the total length of the fruit press 400, from the pivot portions to the handle portions, is in a range of 6-15 inch. In certain embodiments, the total length of the fruit press 400 is in a range of 9-13 inch. In one embodiment, the total length of the fruit press 400 is about 11 inch.

In certain embodiments, the fruit press 400 is a manual fruit press. In certain embodiments, the fruit press 400 may further include a motor and other necessary components to form an electronic fruit press.

At operation, a fruit, such as an orange, a lime, a lemon, or the like, is cut in half (or other type of pieces with at least a skin side and a flesh side). The half fruit is placed between the top plate 420 and the base plate 440, with the cut surface (or the exposed surface or the flesh side) facing the receive portion 441, and the top surface (or the unexposed surface or the skin side) facing the press portion 421. The top plate 420 and the base plate 440 are moved reciprocally to press the half fruit. The skin of the half fruit, when being pressed, moves toward the space between the first middle portion 423 and the second middle portion 443. The first ridges 424 and the second ridges 444 keep the fruit skin in place, breaks the fruit skin for increased surface area of the fruit from which to press for juice as well as to maintain the position of the fruit in place and prevent significant movement (especially inward movement) when the fruit is pressed.

The squeezed juice is received by the receive portion 441, and then passes the through holes 442, toward the container (not shown) under the base plate 440.

In a further aspect, the present invention relates to a press, specifically a food press or a fruit press. The fruit press includes a top plate and a base plate rotatabely connected to each other. The top plate has a first bowl shaped center portion, a first slanted or elevated ring shaped middle portion surrounding the first bowl shaped center portion, and a first rim surrounding the first ring shaped middle portion. The base plate has a second bowl shaped center portion, a second slanted or elevated ring shaped middle portion surrounding the second bowl shaped center portion, and a second rim surrounding the second ring shaped middle portion. The second bowl shaped center portion has multiple through holes at the bottom part thereof. The top plate and the base plate define a resizable space to place a fruit that is cut in half.

At operation, the half fruit is placed between the top plate and the base plate. The top plate and the base plate are rotated toward each other reciprocally, so as to press the half fruit and generate juice. The generated juice is lead out through the through holes. The skin of the half fruit is mainly located between the first middle portion and the second middle portion, such that the fruit press generates more juice than a fruit press in the related art.

In certain embodiments, the upper surface of the second middle portion has multiple stepped structure and multiple ridges, such that the fruit skin can be maintained in place, and spread more completely to generate more juice.

In certain embodiments, the largest dimension at the top of the first and second bowl shaped center portion is about 1.25-1.5 inch, and the largest dimension of the first and second middle portion is about 4 inch.

In a further aspect, the present invention relates to a method of making a fruit press as described above. In certain embodiments, the fruit press is made of a material that is safe for dishwasher. In one embodiment, the fruit press is made of stainless steel. In one embodiment, the fruit press is made of polymers or plastics that has a high hardness.

In certain embodiments, the top plate of the fruit press is integrally formed, and the base plate of the fruit press is integrally formed. In one embodiment, the top plate is made by blanking using one stainless steel plate, and the base plate is mad by blanking using one stainless steel plate.

In certain embodiments, the fruit press is a manual fruit press. In certain embodiments, the fruit press may further include a motor and other necessary components to form an electronic fruit press.

With a press in the related art, during operation, skin of a fruit is rolled in. As a result, more power is needed to squeeze, and there is a lot of un-squeezed juice in the fruit. In contrast, according to certain embodiments of the present application, by designing a press having a flatter base plate and top plate, the skin of a fruit is easy to spread out instead of rolling in. Further, the cutting ridges also help the skin to spread out easily by cutting the skin. Also, small pushing part of the top plate makes it easy to spread out the skin by breaking the summit of the half fruit easily. In addition, according to other embodiments of the present application where steps are available, the steps prevent fruit skin from rolling in, which assures extracting maximum juice with minimum efforts. Ridges in the press with steps also help the skin to spread out.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A press, comprising:
a top plate, comprising:
a press portion having a curved surface;
a first middle portion, extending upward and outward from the press portion, and surrounding the press portion;
a first rim, extending from the first middle portion and surrounding the first middle portion;
a first pivot portion, extending from the first rim, and disposed at a first end of the top plate; and
a first handle portion, extending from the first rim, and disposed at a second end of the top plate that is opposite to the first end of the top plate;
a base plate pivoted to the top plate, comprising:
a receive portion, having a curved surface, and comprising a plurality of through holes formed therethrough;
a second middle portion, extending upward and outward from the receive portion and surrounding the receive portion;
a second rim, extending from the second middle portion and surrounding the second middle portion;
a second pivot portion, extending from the second rim, and disposed at a first end of the base plate; and
a second handle portion, extending from the second rim, and disposed at a second end of the base plate that is opposite to the first end of the base plate; and
a pivot mechanism, configured to connect the top plate with the base plate through the first pivot portion and the second pivotal portion, such that the top plate and the base plate are rotatable relative to each other through the pivot mechanism.

2. The press of claim 1, wherein the press portion comprises a first section, a second section surrounding the first section, and a third section surrounding the second section, wherein a curvature of the third section is greater than a curvature of the first section and a curvature of the second section, and the receive portion comprises a fourth section, a fifth section surrounding the fourth section, and a sixth section surrounding the fifth section, wherein a curvature of the sixth section is greater than a curvature of the fourth section and a curvature of the fifth section.

3. The press of claim 1, wherein a largest length of the receive portion along the horizontal direction is about 1.5 inch.

4. The press of claim 2, wherein a largest length of the press portion along the horizontal direction is 0-10% less than the largest length of the receive portion along the horizontal direction.

5. The press of claim 1, wherein the second middle portion has a bottom length along the horizontal direction in a range of 0.5-3 inch, and a top length along the horizontal direction in a range of 3-5 inch.

6. The press of claim 5, wherein the second middle portion has the bottom length of about 1.5 inch, and the top length of about 4 inch.

7. The press of claim 5, wherein a bottom length of the first middle portion is 0-10% less than the bottom length of the second middle portion, and a top length of the first middle portion is substantially the same as the top length of the second middle portion.

8. The press of claim 1, wherein the second middle portion comprises a plurality of ridges radially disposed at a top surface of the second middle portion, and a number of the ridges is 6.

9. The press of claim 1, wherein an edge of the top plate faces downward, and an edge of the second handle portion faces upward, such that juice leaking is prevented.

10. The press of claim 1, wherein each of the upper plate and the base plate are integrally formed, and the press is made of stainless steel that is dishwashable.

11. A press, comprising:
a top plate, comprising:
a press portion having a first circular bottom portion and a first ring shaped side portion extending outward and upward from the circular bottom portion;
a first middle portion, extending upward and outward from the press portion and surrounding the press portion, and having at least one stepped structure;
a first rim surrounding the first middle portion;
a first pivot portion, extending from the first rim, and disposed at a first end of the top plate; and
a first handle portion, extending from the first rim, and disposed at a second end of the top plate that is opposite to the first end of the top plate;
a base plate pivoted to the top plate, comprising:
a receive portion having a second circular bottom portion, a second ring shaped side portion extending outward and upward from the circular bottom portion, and a plurality of through holes formed therethrough;
a second middle portion, extending upward and outward from the receive portion and surrounding the receive portion, and having at least one stepped structure;
a second rim surrounding the second middle portion;
a second pivot portion, extending from the second rim, and disposed at a first end of the base plate; and
a second handle portion, extending from the second rim, and disposed at a second end of the base plate that is opposite to the first end of the base plate; and
a pivot mechanism, configured to connect the top plate with the base plate through the first pivot portion and the second pivotal portion, such that the top plate and the base plate are rotatable relative to each other through the pivot mechanism.

12. The press of claim 11, wherein a diameter at a top of the second ring shaped side portion is in a range of 1-2 inch, and a diameter of the second circular bottom portion is in a range of 1-1.5 inch.

13. The press of claim 12, wherein the diameter at a top of the second ring shaped side portion is about 1.5 inch, and a diameter of the second circular bottom portion is about 1.25 inch.

14. The press of claim 11, wherein a size and shape of the press portion are 0-10% smaller than a size and shape of the receive portion.

15. The press of claim 11, wherein each of the first middle portion and the second middle portion comprises 3 stepped structures.

16. The press of claim 11, being made of stainless steel.

17. A press, comprising:
a top plate, comprising:
a press portion having a bowl shape;
a first middle portion, extending upward and outward from the press portion and surrounding the press portion; and
a first rim surrounding the first middle portion; and
a base plate pivoted to the top plate, comprising:
a receive portion having a bowl shape, and comprising a plurality of through holes formed therethrough;
a second middle portion, surrounding the receive portion, and extending upward and outward from the press portion; and
a second rim surrounding the second middle portion.

18. The press of claim 17, wherein a largest dimension of the press portion and the receive portion along the horizontal direction is about 1.5 inch, and a largest dimension of the first rim and the second rim along the horizontal direction is about 4 inch.

19. The press of claim 17, wherein each of the first middle portion and the second middle portion comprises 2-6 stepped structures.

20. The press of claim 17, wherein the second middle portion comprises a plurality of ridges radially disposed at an inner surface of the second middle portion.
